(19) United States
(12) Patent Application Publication
(10) Pub. No.: US 2016/0228224 A1
(43) Pub. Date: Aug. 11, 2016

(54) PORTABLE TEETH RINSING MACHINE

(71) Applicant: MOTION DENTAL EQUIPMENT CORP., New Taipei City (TW)

(72) Inventor: Wen-Hao WANG, New Taipei City (TW)

(21) Appl. No.: 14/614,984

(22) Filed: Feb. 5, 2015

(51) Int. Cl. A61C 17/02; A61C 17/022

(52) U.S. Cl. CPC A61C 17/0202; A61C 17/0217; A61C 17/022

(57) ABSTRACT

A portable teeth rinsing machine includes a base and a spray gun. The base includes an air compression device to generate compressed air and a liquid compression device to generate a compressed liquid. The spray gun communicates with the air compression device and the liquid compression device, and includes an air directing passage to get the compressed air, a liquid directing passage to get the compressed liquid, a first depressing portion located in the air directing passage and triggered to output the compressed air, and a second depressing portion located in the liquid directing passage and triggered to output the compressed liquid.

### FIELD OF THE INVENTION

The present invention relates to a portable teeth rinsing machine and particularly to a portable teeth rinsing machine that is small in size and easy to carry around.

### BACKGROUND OF THE INVENTION

Teeth rinsing machines are known in the art. For instance, Taiwan Patent No. M462588 discloses a portable teeth rinsing machine control valve which can provide water ejection, but not air spraying. Hence it cannot provide many types of cleaning as desired when in use, and still has room for improvement.

### SUMMARY OF THE INVENTION

The primary object of the present invention is to overcome problem of the conventional technique of unable to provide water ejection and air spraying.

To achieve the foregoing object the present invention provides a portable teeth rinsing machine that includes a base and a spray gun. The base includes an air compression device to generate compressed air and a liquid compression device to generate a compressed liquid. The spray gun communicates with the air compression device and the liquid compression device, and includes an air directing passage to get the compressed air, a liquid directing passage to get the compressed liquid, a first depressing portion located in the air directing passage and triggered to output the compressed air, and a second depressing portion located in the liquid directing passage and triggered to output the compressed liquid.

In one embodiment the air compression device includes an air pump, an air pipe communicating with the air pump to transport the compressed air and a first pressure switch communicating with the air pipe and triggered by the pressure of the compressed air in the air pipe to control the air pump.

In another embodiment the liquid compression device includes a liquid pump, a liquid pipe communicating with the liquid pump to transport the compressed liquid and a second pressure switch communicating with the liquid pipe and triggered by the pressure of the compressed liquid in the liquid pipe to control the liquid pump.

In yet another embodiment the portable teeth rinsing machine further includes a cistern which has a housing compartment, an opening at one side of the housing compartment and communicating therewith, a wall at an opposite side of the housing compartment and connecting therewith, and a valve located on the wall. The valve has an open state pushed to provide the liquid to the liquid pump, and a closed state closed in normal conditions.

In yet another embodiment the portable teeth rinsing machine further includes a holder installed on the base to hold the spray gun and a safety switch located on the holder. The safety switch has an open circuit state pushed by the spray gun to set off electric connection of the air compression device and the liquid compression device, and a conductive state without being pushed by the spray gun to set on electric connection of the air compression device and the liquid compression device.

By means of the structure set forth above, compared with the conventional techniques, the invention provides many advantageous features, notably:

1. The invention holds the spray gun through the holder located on the base. The holder is smaller in size and includes the safety switch, erroneous touching of the spray gun to output the compressed air or the compressed liquid can be prevented.

2. Through the first pressure switch and the second pressure switch to control respectively the air pump and the liquid pump, idle operation of the air pump and the liquid pump can be avoided to increase the life span of the air pump and the liquid pump.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the invention.

FIG. 2 is a sectional view of the base of an embodiment of the invention.

FIG. 3 is a schematic view of the air compression device of an embodiment of the invention.

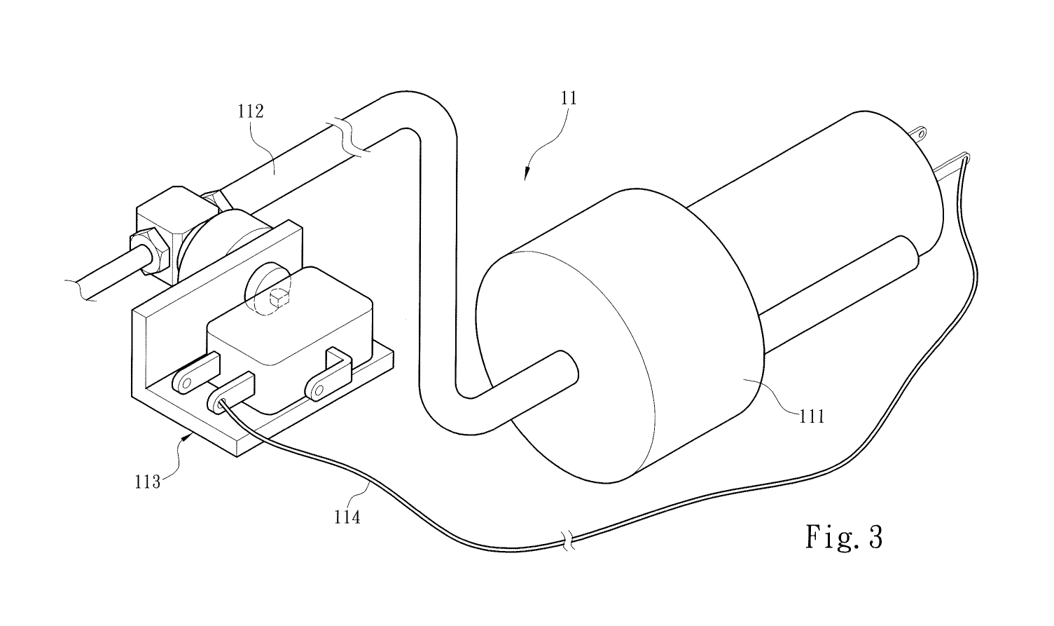

FIG. 4 is a schematic view of the liquid compression device of an embodiment of the invention.

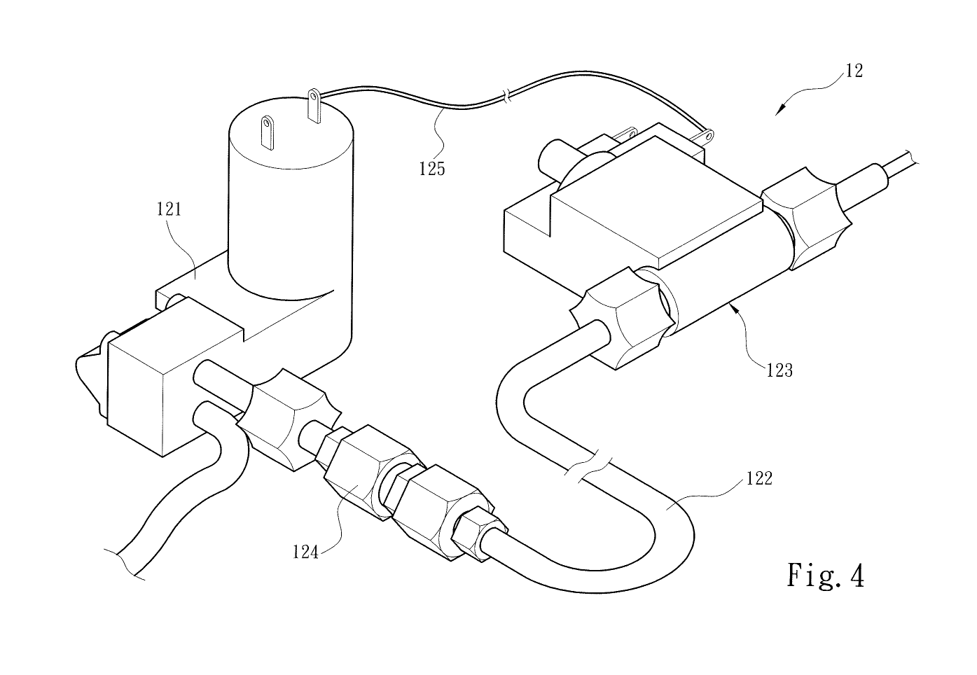

FIG. 5 is a unit block diagram of the base of an embodiment of the invention.

### DETAILED DESCRIPTION OF THE PREFERRED EMBODIMENT

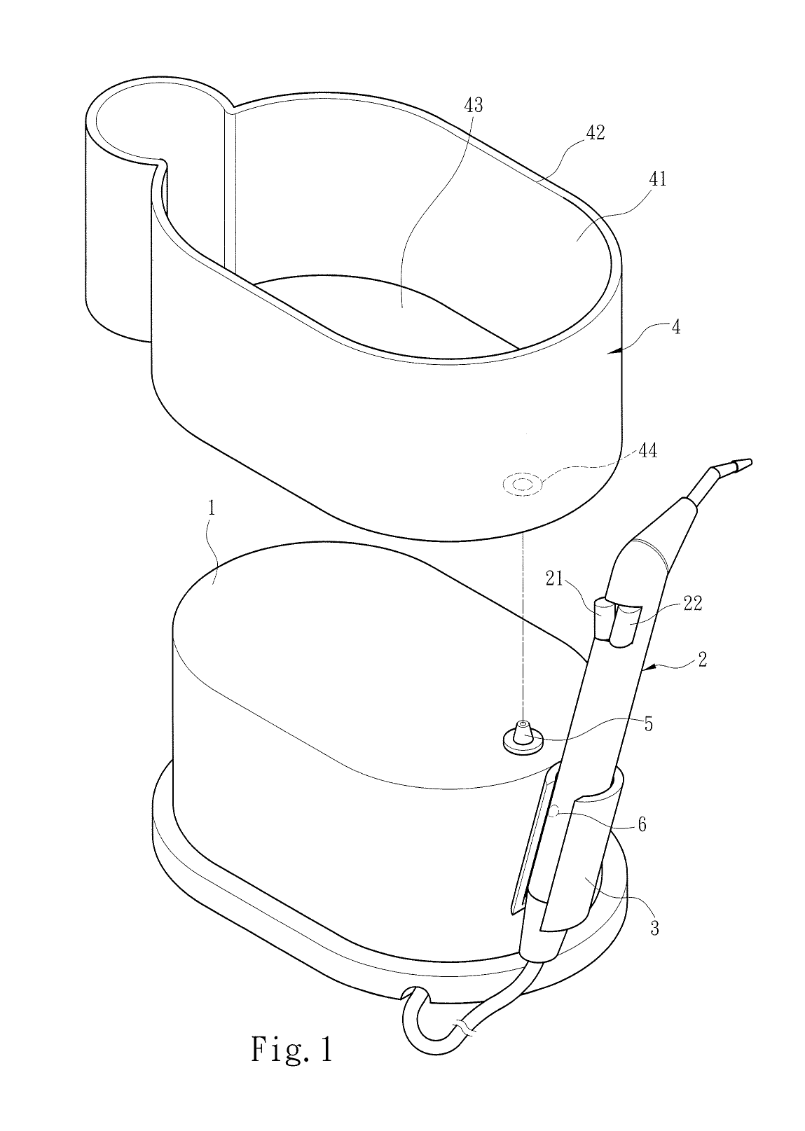

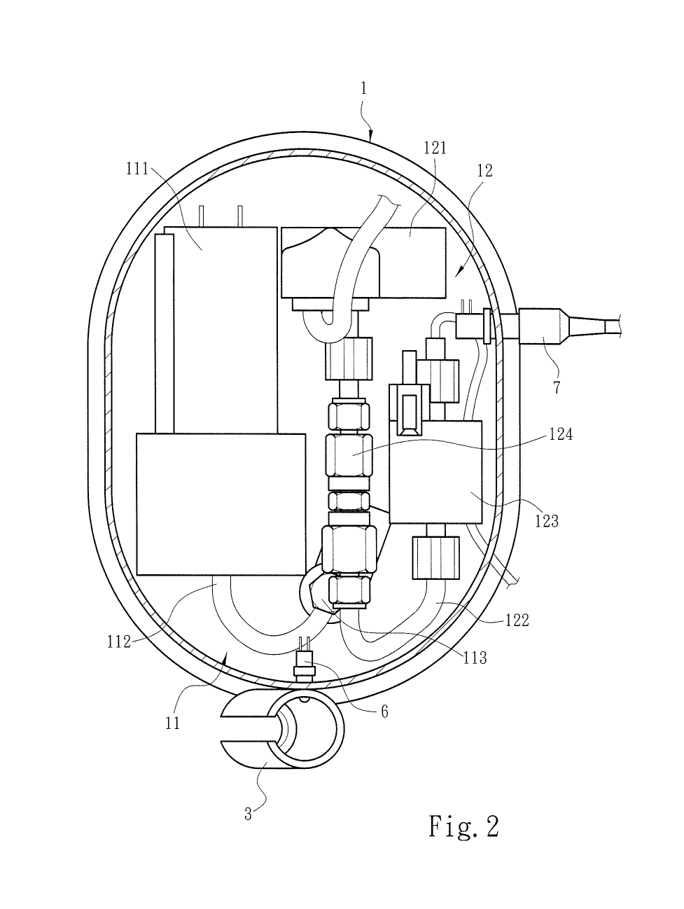

Please referring to FIGS. 1 and 2, the present invention aims to provide a portable teeth rinsing machine that includes a base 1, a spray gun 2 coupled on the base 1, a holder 3 to hold the spray gun 2 and a cistern 4 located on the base 1. The base 1 includes an air compression device 11 and a liquid compression device 12. The air compression device 11 aims to generate compressed air. The cistern 4 holds a liquid and supplies the liquid to the liquid compression device 12 which generates a compressed liquid. The spray gun 2 aims to output the compressed air and the compressed liquid for users to cleanse teeth. The air compression device 11 includes an air pump 111, an air pipe 112 communicating with the air pump 11 to transport the compressed air, a first pressure switch 113 communicating with the air pipe 112 and triggered by the pressure of the compressed air in the air pipe 112 to control the air pump 111, and a first transmission portion 114 electrically connected to the air pump 111 and the first pressure switch 113. When the first pressure switch 113 is triggered by the internal pressure of the air pipe 112 it controls operation of the air pump 111. The liquid compression device 12 includes a liquid pump 121, a liquid pipe 122 communicating with the liquid pump 121 to transport the compressed liquid, a second pressure switch 123 communicating with the liquid pipe 122 and triggered by the pressure of the compressed liquid in the liquid pipe 122 to control the liquid pump 121, a check valve 124 bridging the liquid pump 121 and the liquid pipe 122, and a second transmission portion 125 electrically connected to the liquid pump 121 and the second pressure switch 123. The check valve 124 can prevent the compressed liquid from flowing back to the liquid pump 121 to avoid indirectly polluting the liquid. When the second pressure switch 123 is triggered by the internal pressure of the liquid pipe 122 it controls operation of the liquid pump 121. The first pressure switch 113 and the second pressure switch 123 are respectively a pressure control device, its working principle is to issue an alarm or a control signal when the measured pressure has reached a rated value.

Also referring to FIG. 1, the spray gun 2 is communicating with the air compression device 11 and the liquid compression device 12, and includes an air directing passage (not shown in the drawings) to get the compressed air, a liquid directing passage (not shown in the drawings) to get the compressed liquid, a first depressing portion 21 located in the air directing passage and triggered to output the compressed air, and a second depressing portion 22 located in the liquid directing passage and triggered to output the compressed liquid. The spray gun 2 can be a three-way spray gun, and can generate a corresponding amount of the compressed air and the compressed liquid according to the amount of pressure depressed by a user on the first depressing portion 21 and the second depressing portion 22. The holder 3 is installed on the base 1 to hold the spray gun 2. The cistern 4 has a housing compartment 41, an opening 42 located at one side of the housing compartment 41 and communicating with therewith, a wall 43 located at an opposite side of the housing compartment 41 and communicating therewith, and a valve 44 located on the wall 43. The valve 44 has an open state pushed to provide the liquid to the liquid pump 121, and a closed state closed in normal conditions. The valve 44 is made from rubber. The cistern 4 has a storage state to cover the base 1 and a use state mounted onto the base 1 to hold the liquid. Moreover, the valve 44 can be pushed by an input tube 5 connected to the liquid pump 121 to output the liquid to the liquid pump 121. The holder 3 also has a safety switch 6 located thereon that has an open circuit state pushed by the spray gun 2 to set off electric connection of the air compression device 11 and the liquid compression device 12, and a conductive state without being pushed by the spray gun 2 to set on electric connection of the air compression device 11 and the liquid compression device 12.

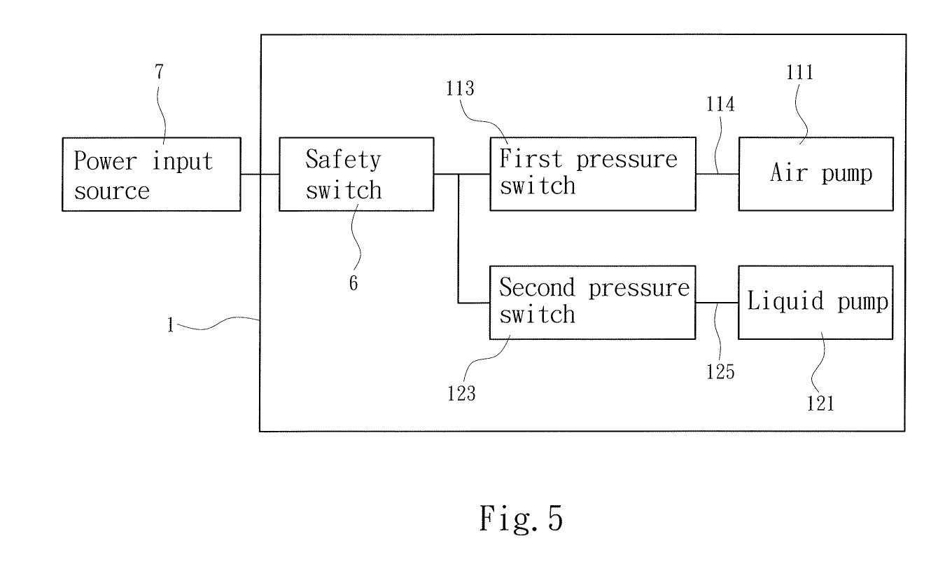

Also referring to FIGS. 1 and 5, first, assumed that the cistern 4 covers the base 1 in advance. In addition, the invention also is connected to a power input source 7. The safety switch 6 is electrically connected to the power input source 7 to set on or set off electrical connection therewith. The first pressure switch 113 and the second pressure switch 123 are connected respectively to the safety switch and the air pump 111 and the liquid pump 121, as shown in FIG. 5. When in use, fetch the cistern 4 and hold the liquid in the housing compartment 41. When the spray gun 2 is held on the holder 3 and the safety switch 6 is butted, the air pump 111 and the liquid pump 121 are set off electrically, hence the air pump 111 and the liquid pump 121 stop generating the compressed air and the compressed liquid. When the user wants to use and removes the spray gun 2 from the holder 3, the safety switch 6 is not being butted by the spray gun 2, and the air pump 111 and the liquid pump 121 are set on electrically, and the first pressure switch 113 and the second pressure switch 123 detect respectively the pressure in the air pipe 112 and the liquid pipe 122. When the first pressure switch 113 and the second pressure switch 123 detect the pressure being too small, they control the air pump 111 and the liquid pump 121 to generate the compressed air and the compressed liquid. When the pressure has reached a preset pressure the first pressure switch 113 and the second pressure switch 123 set off electrical connection between the power input source 7 and the air pump 111 and the liquid pump 121 so that the air pump 111 and the liquid pump 121 stop operation. When the user depresses respectively the first depressing portion 21 and the second depressing portion 22, the spray gun 2 outputs respectively the compressed air and the compressed liquid. In addition, when the user depresses the first depressing portion 21 and the second depressing portion 22 at the same time the spray gun 2 outputs the compressed air and the compressed liquid at the same time to generate atomized spray. When the user has finished using, cover the cistern 4 over the base 1 for storage.

As a conclusion, the invention can hold the liquid in the cistern, and generate the compressed air and the compressed liquid through the air pump and the liquid pump. In addition, the air pump and the liquid pump can be controlled respectively through the first pressure switch and the second pressure switch. Moreover, through the safety switch erroneous touching of the spray gun held in the holder can be prevented to avoid delivering the compressed air or the compressed liquid.

What is claimed is:

1. A portable teeth rinsing machine, comprising:
a base including an air compression device to generate compressed air and a liquid compression device to generate a compressed liquid; and
a spray gun which communicates with the air compression device and the liquid compression device and includes an air directing passage to get the compressed air, a liquid directing passage to get the compressed liquid, a first depressing portion located in the air directing passage and triggered to output the compressed air, and a second depressing portion located in the liquid directing passage and triggered to output the compressed liquid.

2. The portable teeth rinsing machine of claim 1, wherein the air compression device includes an air pump, an air pipe communicating with the air pump to transport the compressed air and a first pressure switch communicating with the air pipe and triggered by the pressure of the compressed air in the air pipe to control the air pump.

3. The portable teeth rinsing machine of claim 1, wherein the liquid compression device includes a liquid pump, a liquid pipe communicating with the liquid pump to transport the compressed liquid and a second pressure switch communicating with the liquid pipe and triggered by the pressure of the compressed liquid in the liquid pipe to control the liquid pump.

4. The portable teeth rinsing machine of claim 1 further including a cistern which includes a housing compartment, an opening at one side of the housing compartment to connect thereof, a wall located at an opposite side of the housing compartment to connect thereof, and a valve located on the wall; wherein the valve includes an open state butted to provide the liquid to the liquid pump and a closed state closed in normal conditions.

5. The portable teeth rinsing machine of claim 1 further including a holder installed on the base to hold the spray gun and a safety switch located on the holder, the safety switch including an open circuit state pushed by the spay gun to set off electric connection of the air compression device and the liquid compression device, and a conductive state without being pushed by the spray gun to set on electric connection of the air compression device and the liquid compression device.
